(19) United States
(12) Patent Application Publication
(10) Pub. No.: US 2010/0228633 A1
(43) Pub. Date: Sep. 9, 2010

(54) METHOD AND SYSTEM FOR HOSTING A METAVERSE ENVIRONMENT WITHIN A WEBPAGE

(76) Inventors: Stella Villares Guimarães, Sao Paulo (BR); Dino Vettorello Filho, Sao Paulo (BR)

Correspondence Address: LACKENBACH SIEGEL, LLP, LACKENBACH SIEGEL BUILDING, 1 CHASE ROAD, SCARSDALE, NY, 10583, US

(21) Appl. No.: 12/720,337

(22) Filed: Mar. 9, 2010

Related U.S. Application Data
(60) Provisional application No. 61/158,484, filed on Mar. 9, 2009.

(51) Int. Cl. G06F 3/048; G06Q 30/00

(52) U.S. Cl. 705/14.69; 715/757; 705/1.1

(57) ABSTRACT

The invention is a method and system for hosting a metaverse environment within a webpage and navigating within that environment. The metaverse is established by embedding an interface in a web page, then creating an avatar when a mouse, under control of an environment user, moves over the interface. A virtual reality street, serving as the central point of the environment, and associated with a particular URL, is established and placed on the bottom of a webpage. The street is customized with a plurality of facades, and the avatar is caused, by the user, to move up or down the street. The movement of the avatar allows it to interact with the facades or activities that are built into the street. Navigation of the avatar to the end of the street causes the avatar to select from among one or more choices for selecting a next web page.

### CROSS REFERENCE TO RELATED APPLICATIONS

This application claims priority from U.S. Provisional Patent Application Ser. No. 61/158,484, filed Mar. 9, 2009, the entire contents of which is herein incorporated fully by reference.

### BACKGROUND OF THE INVENTION

1. Field of the Invention

The present invention relates to the interface requirements for a metaverse environment, and for the engagement of new users within said environment. More specifically, the present invention relates to embedding a metaverse interface directly within specific web pages and creating an avatar capable of interacting within the metaverse when a system user engages the interface with the movement of a mouse. A webring is then employed to connect all the web pages in a unique map or grid.

2. Description of the Related Art

The related art involves the creation of, and passage through, three dimensional (3D) and virtual computing worlds. Virtual worlds exist within the greater World Wide Web (the web), or in localized networks. The term “metaverse”, to describe a particular virtual world, has evolved from the concepts conceived by the writer Neal Stephenson in his 1992 book “Snow Crash”. In that book, Stephenson imagines a virtual world called the “Metaverse”. Access to the Metaverse was achieved by system users through their computers. In the virtual world people are represented by depictions called “avatars”. Avatars were first described in the 1980s and have come to mean a computer user's 3D (in gaming) depiction of themselves based on the image that they want to show other users of the metaverse. A 2D depiction (picture) can also be used in certain other forums. Typically, within the metaverse, the level of detail or quality of a person's avatar is generally representative of their social status. A highly detailed avatar might represent a skilled player within the metaverse, while an “off the rack” avatar suggested a beginner's status or a lack of sophistication. Avatars are also used within instant messaging programs such as WINDOWS LIVE MESSENGER, but they tend to be smaller and less sophisticated than their gaming counterparts. Other examples of avatars include “bots” or Structured Language Processing Avatars (SLP) avatars.

Gaming avatars are the physical representation of their game user. They are created by building on a base model (a template) and adding various accessories or traits which personalize the avatar.

In the metaverse, the central point for building the virtual world is the “Street”. Like their real life counterparts, streets are lined with stores, apartment buildings, lights, and signage. Streets, in turn, give way to side streets which are similarly built upon and developed.

Development of the virtual worlds has been furthered by such companies as Second Life and There.com. Second Life, or SL, is a clear industry favorite. There appears uncertainty in clearly classifying the generational development of the metaverse; but, the current state of the art falls within an early generation of the metaverse environment (either late stage 1G, or early 2G). Common standards for 3D imaging products are not harmonized. Some early products were developed in VRML (Virtual Reality Markup Language) and later X3D. Currently, the norm has been to utilize X3D as a base standard while permitting developers to add extensions for particular functionality. The effect, on an industry-wide basis, is the current non-standard 3D environment. As products like Second Life do not run in a web browser, or use Hypertext Transfer Protocol (HTTP-HTTP is defined by RFC 2616, which is a protocol developed by the World Wide Web Consortium and the Internet Engineering Task Force. It is request/response interchange between a client, or end user, and a server, or web site), they only truly become web-enabled when they are linked together to form a metaverse.

What is not appreciated by the prior art is the interface required within the metaverse to overcome the use of non-standard interchanges, and the engagement of new users.

Accordingly, there is a need for an improved interface that can be directly embedded in a web page and can be activated so as to create an avatar. In turn, a model is required that will connect all the pages having embedded interfaces into a unique map or grid.

### ASPECTS AND SUMMARY OF THE INVENTION

An aspect of the present invention is to provide a model wherein a small piece of a metaverse is placed inside each web page. Each location (or street) within the metaverse is associated with a URL which, in turn, creates a unique 3D identifier and interface for the web page. All the pages are then connected utilizing a web structure known as a webring. A webring is a collection of websites from within the Internet which are joined together in a circular structure. Each site within the webring has a common navigation bar. The bar contains links to the previous site in the ring and to the next site in the ring. By clicking on a “next” button (or equivalent) repeatedly, the site surfer will eventually circumnavigate the ring. To avoid the problem where the ring may be broken by a non-functioning site, a central site can be employed that has links to each of the other member sites.

Another aspect of the present invention is to provide a webring within a 3D interface to create a new way of navigating the Internet.

Another aspect of the present invention, is to provide web page-based spatial platform for internet navigation and social interaction. This object is accomplished by bringing a linked navigation concept into an embedded widget metaverse.

Another aspect of the present invention is to provide a metaverse (commercially referred to as URBii) hosted in a webpage in the form of a banner or widget. The banner simulates a street, and it may have a number of content sites such as: houses, buildings, shops, parks, etc. In the metaverse environment people (shown as avatars) can meet, chat, acquire products, and interact with certain contents.

Another aspect of the present invention is the form of navigation. Streets within the metaverse are linked to one another, inside a grid system. As the user reaches the end of a street (to the right or to the left), the user is directed to other streets hosted in other webpages or websites.

The present invention relates to a method and system for hosting a metaverse environment within a webpage and navigating within that environment. The metaverse is established by embedding an interface in a web page, then creating an avatar when a mouse, under control of an environment user, moves over the interface. A virtual reality street, serving as the central point of the environment, and associated with a particular URL, is established and placed on the bottom of a webpage. The street is customized with a plurality of facades, and the avatar is caused, by the user, to move up or down the street. The movement of the avatar allows it to interact with the facades or activities that are built into the street. Navigation of the avatar to the end of the street causes the avatar to select from among one or more choices for selecting a next web page.

According to an embodiment of the present invention there is provided a method and system for hosting a metaverse environment within a webpage and navigating within that environment. The metaverse is established by embedding an interface in a web page, then creating an avatar when a mouse, under control of an environment user, moves over the interface. A virtual reality street, serving as the central point of the environment, and associated with a particular URL, is established and placed on the bottom of a webpage. The street is customized with a plurality of facades, and the avatar is caused, by the user, to move up or down the street. Acquisition of the street by the user is accomplished through a payment of a fee by the user to the metaverse environment.

The method of creating an avatar comprises the step of initiating an application which allows a user to activate a customization widget. The customization widget is activated to allow the user to select one or more visual characteristics that can be applied to the avatar. The user then makes the selection of one or more visual characteristics from a list determinative of a customized avatar.

The movement of the avatar allows it to interact with the facades or activities that are built into the street by one or more system users. Navigation of the avatar to the end of the street causes the avatar to select from among one or more choices for selecting a next web page. The avatar interfaces with one of the choices so as to select a next web page to navigate; then, the avatar moves from its present street to a next street.

Navigation is facilitated by the system allowing the user to host the metaverse environment within a webpage, and wherein the system further comprises a web-based server having a plurality of web pages accessible therefrom. There is provided a first interface between the plurality of web pages and a user data processing system; the data processing system includes a monitor and a mouse. Further, there is a second interface embedded in a web page wherein the user can create an avatar when a mouse under control of the user moves over the second interface. The avatar is capable of moving over a virtual reality street capable of being acquired from the metaverse environment, and wherein the virtual reality street is associated with a particular URL. The virtual reality street is placed on the bottom of a webpage where it is embedded on the site content of the web page.

The web page itself further comprises a browser window viewable by the system user. The viewable webpage has three subsets which include: a first subset displaying a listing for a site URL; a second subset displaying site content; and, a third subset of said browser window displaying a virtual world application which is embedded in the site content.

More specifically, the present invention provides for a method of loading a metaverse environment within a networked data processing system. The method comprises the step of utilizing hypertext transfer protocol (HTTP) to get a site connection from a browser. The method then returns a set of selected content from the site to the browser, before utilizing HTTP Get protocol to refer to a site URL so as to access an application server. Once accessed, the method transmits a virtual world ID URL from the application server to a database; and, then transmits the selected Virtual World Application (VWAPP) content to the browser from the database.

The method and system further comprises customization means for customizing the virtual reality street. Among the customization options is a plurality of facades which can include: one or more houses; one or more commercial buildings; and, one or more street lights. Additionally, the method and system further comprises means for utilizing an internal currency that can be converted within said environment into any currency in the real world. The purpose of the currency is to facilitate buying and selling within the virtual world while utilizing real world examples. For example, the customizing step and the means for doing so allow the user (hoster) to sell virtual media space to an advertiser within the metaverse.

The above, and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of the metaverse hoster web page.

FIG. 2 is a sequence diagram for loading of the metaverse environment.

FIG. 3 is a relationship diagram describing the embed mode for the metaverse interface.

FIG. 4 is a relationship diagram describing the relationship view of multiple users, represented by avatars, when drawing data from the database of a virtual world server.

FIG. 5 is a sequence diagram demonstrating the movement of the avatar from one web page to another.

FIG. 6 is a simulation distribution model describing the action sequencing between two clients as represented by avatars.

FIG. 7A is a screen from the webpage where the metaverse selection widget is closed.

FIG. 7B is a screen from the webpage where the widget has been opened and the virtual reality street is shown.

FIG. 8 is the log-in screen for a system user.

FIG. 9 is a screen from the webpage where the widget has been opened and the options for strolling by the avatar are available.

FIG. 10A is a screen from the webpage where the widget has been opened and a chat sequence has been selected.

FIG. 10B is a screen flowing from FIG. 10A that continues the chat sequence.

FIG. 11 is a screen from the webpage where the widget has been opened and a street customization sequence has been selected.

FIG. 12 is a screen from the webpage where the widget has been opened and the ability to view the grid for the metaverse has been selected.

FIG. 13 is a screen from the webpage showing specific advertising content incorporated into the page.

FIG. 14A is a flowchart of the method of the present invention.

FIG. 14B is a continuation of the method of the present invention as is shown in FIG. 14A.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

The present invention is a method and system created to host a metaverse environment within any given page on the internet. That environment is a virtual reality street, associated with a particular URL, that is located at the bottom of every webpage like a standard ad banner. When a user moves over the interface for the first time, an avatar is automatically created, and the use (through the avatar) is free to start exploring.

The street itself, located within the banner, is populated by façades, which can include: buildings; houses; shops; and, more—just as in the real world. The contents of the street can also be customized. Each facade can contain external links or internal applications that can be developed by anyone. When users interact with a given façade, they can access content in a variety of ways; these include: games; audio and video players; even shops that sell virtual or real world products.

The user's avatar moves up and down the street, interacting with built-in storefronts and chatting with other avatars. When an avatar reaches the end of the street, users can choose to navigate to other streets, hosted in different web pages. A webring concept is employed to connect all the web pages in a grid, according to content, creating a global network of neighborhoods. Users can also create their own personal neighborhoods, by connecting and arranging their favorite system streets. A user's point of view can be shared with their friends, generating alternative strolling routes.

The present invention provides the platform that enables this metaverse, controlling the grid that shows street connections. The system also controls an internal currency that can be converted to any real-world counterpart, maintaining control over all financial transactions. Additionally, the system provides the hosting and controls the quality for all the content in this metaverse.

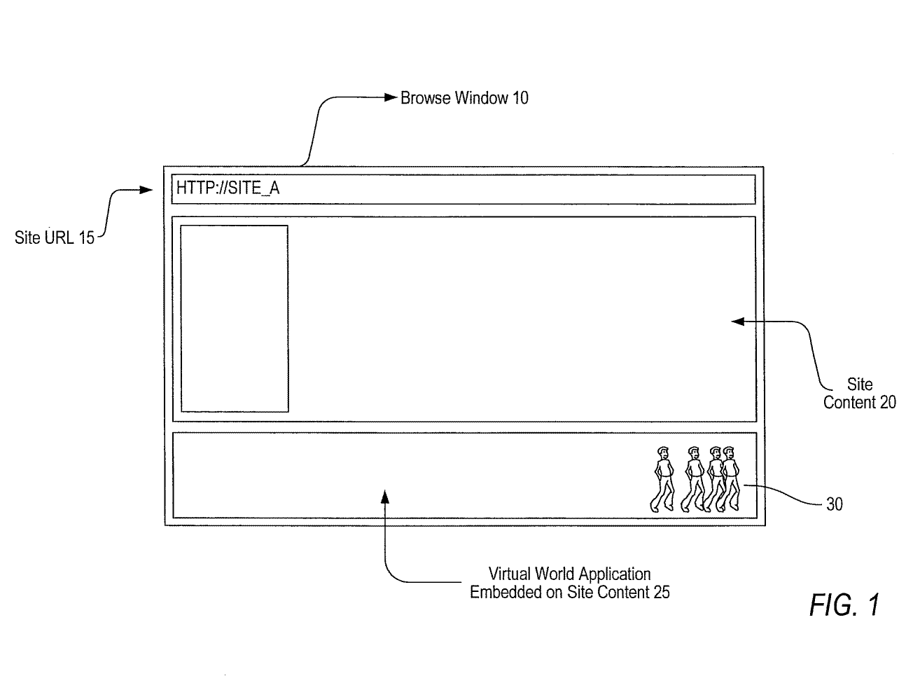

Turning to FIG. 1 there is shown a block diagram of the metaverse hoster web page. The web page itself further comprises a browser window 10 viewable by the system user. The viewable webpage has three subsets which include: a first subset 15 displaying a listing for a site URL; a second subset 20 displaying site content; and, a third subset 25 of said browser window displaying a virtual world application which is embedded in the site content and capable of being “strolled” by an avatar 30.

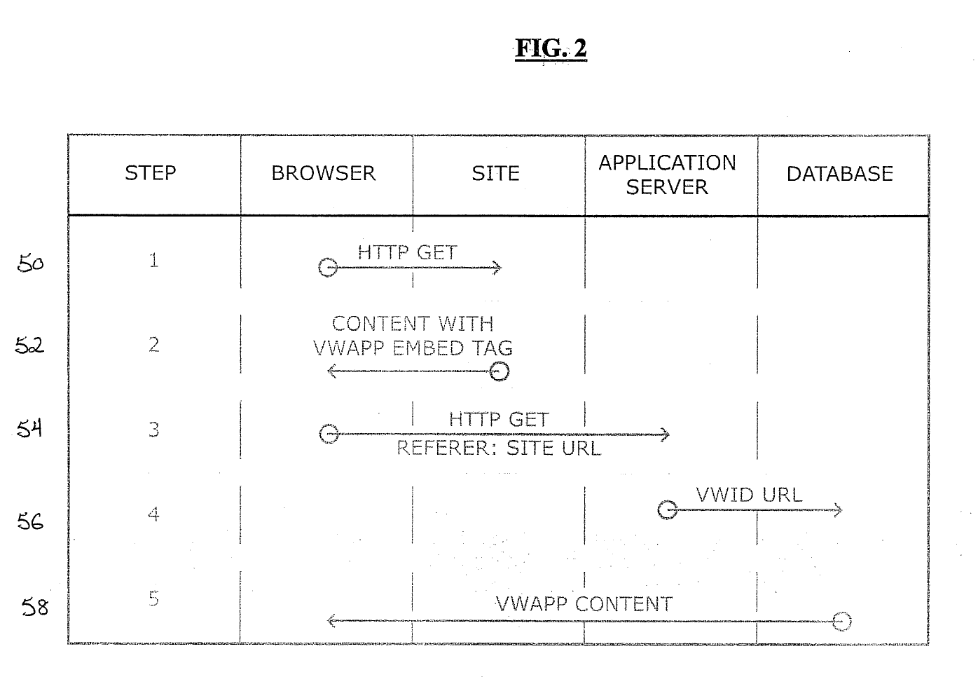

FIG. 2 is a sequence diagram for loading of the metaverse environment wherein at step 50 hypertext transfer protocol (HTTP) is utilized to get a site connection from a browser. The method then returns a set of selected content, at step 52 from the site to the browser, before utilizing HTTP Get protocol, at step 54, to refer to a site URL so as to access an application server. Once accessed, the method transmits, at step 56, a virtual world ID URL from the application server to a database; and, then transmits the selected Virtual World Application (VWAPP) content to the browser from the database at step 58.

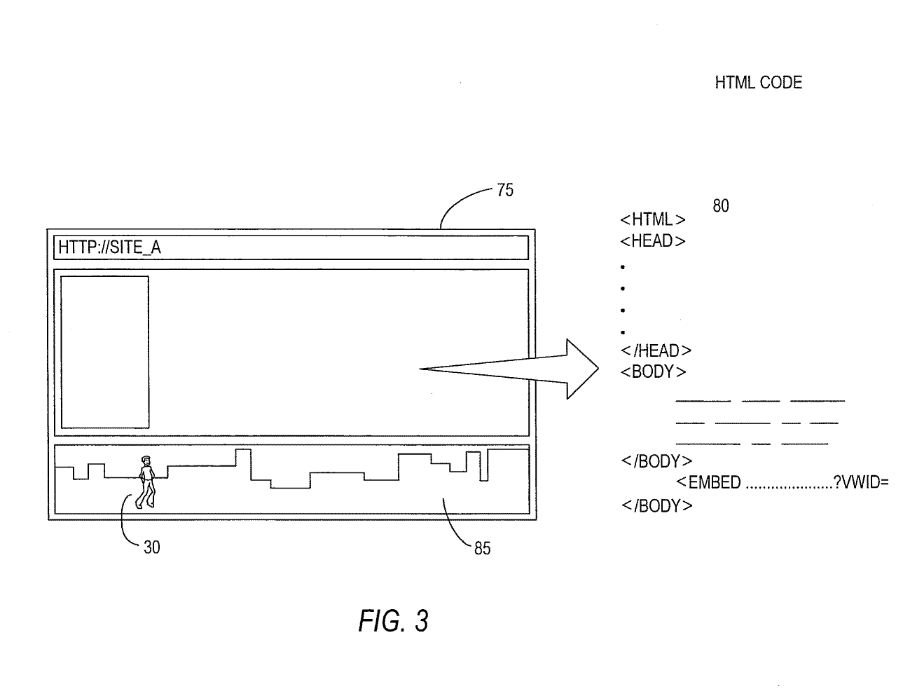

Turning next to FIG. 3, there is shown a relationship diagram describing the embed mode for the metaverse interface. Avatar 30 is shown strolling within the street 85 of the web page 75. The attributes of avatar 30 are assigned in hypertext markup language (HTML) 80 and assigned an embed code representative of the placement within the associated webpage 75.

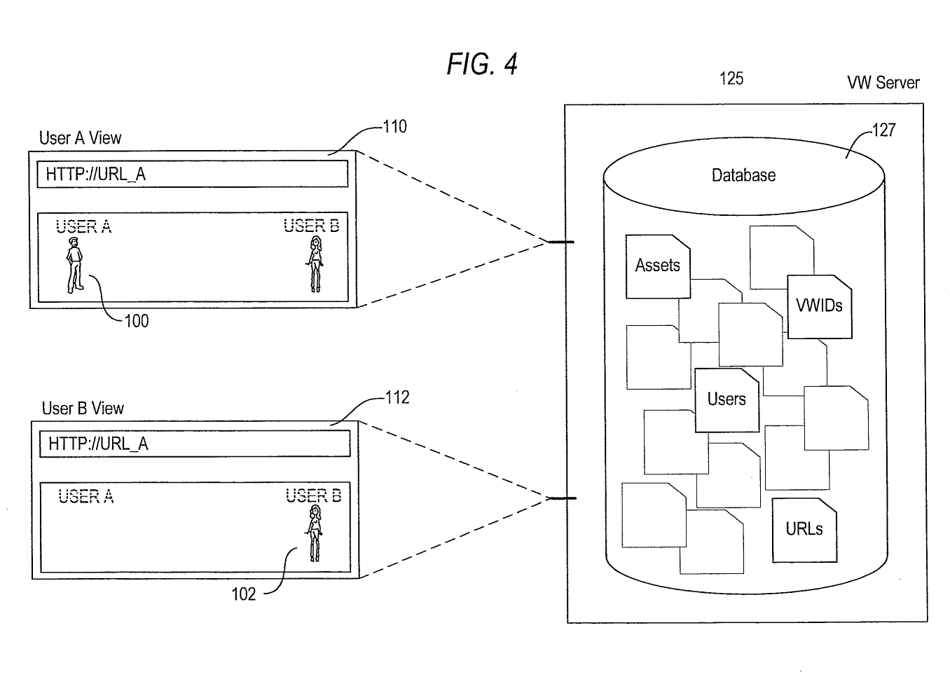

Once active, the avatars associated with each system user inter-relate with those of the other users. This relationship is shown in FIG. 4 which is a relationship diagram describing the relationship view of multiple users, represented by avatars 110, 112, when drawing data from the database 127 of a virtual world server 125. The relationship is described by the visual depiction 110 of the view seen by user A. User A sees their associated avatar 100 as a distinct representation as opposed to the slightly muted representation of the user B avatar. The viewpoint of user B is reversed in that the depiction of the user B avatar 102 is distinct, while that of the user B avatar is muted.

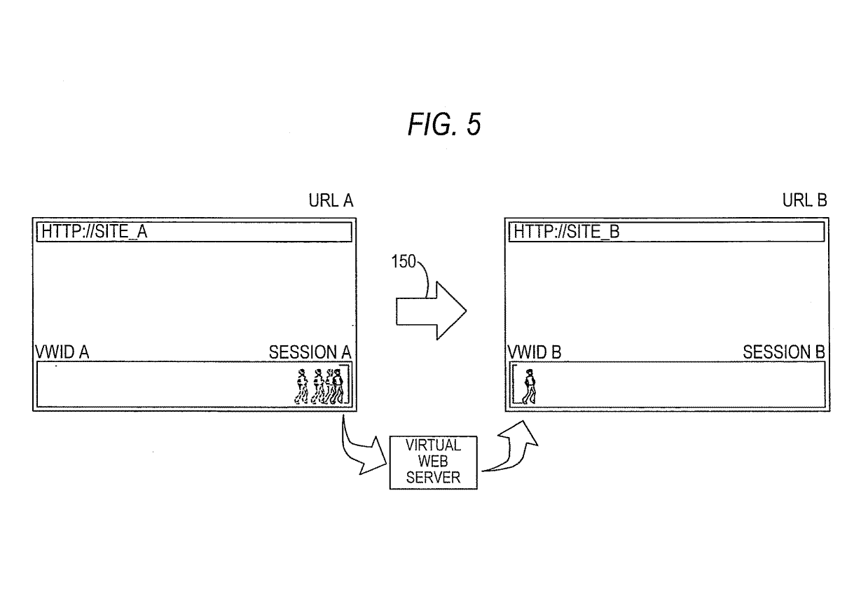

Movement of the avatars within a page is relatively simple; however, movement from one page to another as shown in FIG. 5 involves the use of a webring to link page“ends” together so as to create the world in which the avatar moves. FIG. 5 is a sequence diagram demonstrating the movement 150 of the avatar from one web page to another as hosted by the virtual web server 125 shown in FIG. 4.

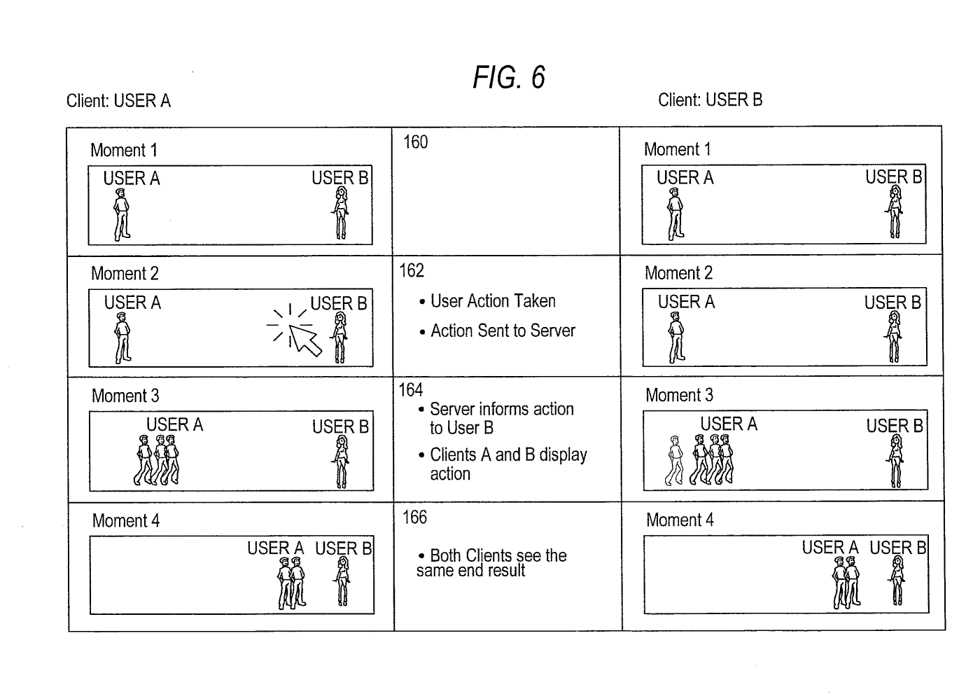

Turning next to FIG. 6 there is shown a simulation distribution model describing the action sequencing between two clients as represented by avatars. In step 160 (moment 1), user A and user B as represented by their respective avatars are shown co-exiting within the metaverse. In step 162 (moment 2), a user action is taken and the action sent to the virtual web server 125. The sequence moves from step 162 to step 164 where the virtual web server informs user B of the action taken; and, representative avatars display the action on the screen. At step 166, both clients see the same end result.

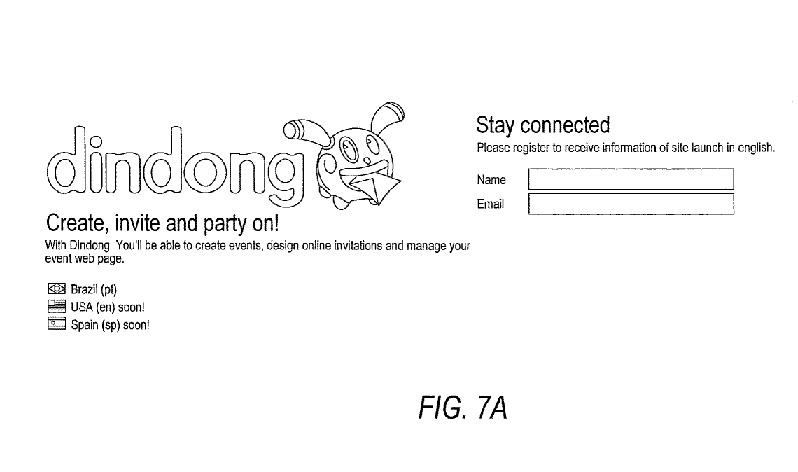

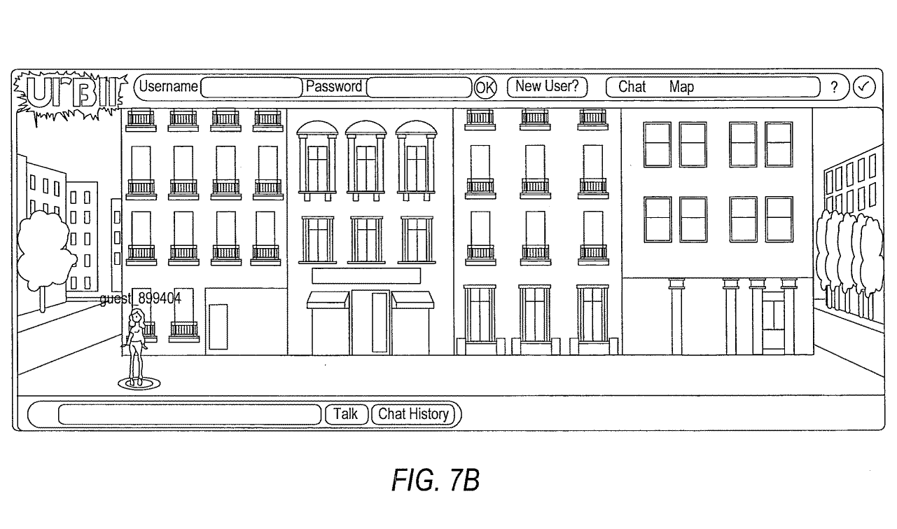

FIGS. 7A through 13 describe, utilizing actual webpage screens, the sequence of events as a web page is first displayed with a metaverse widget displayed.

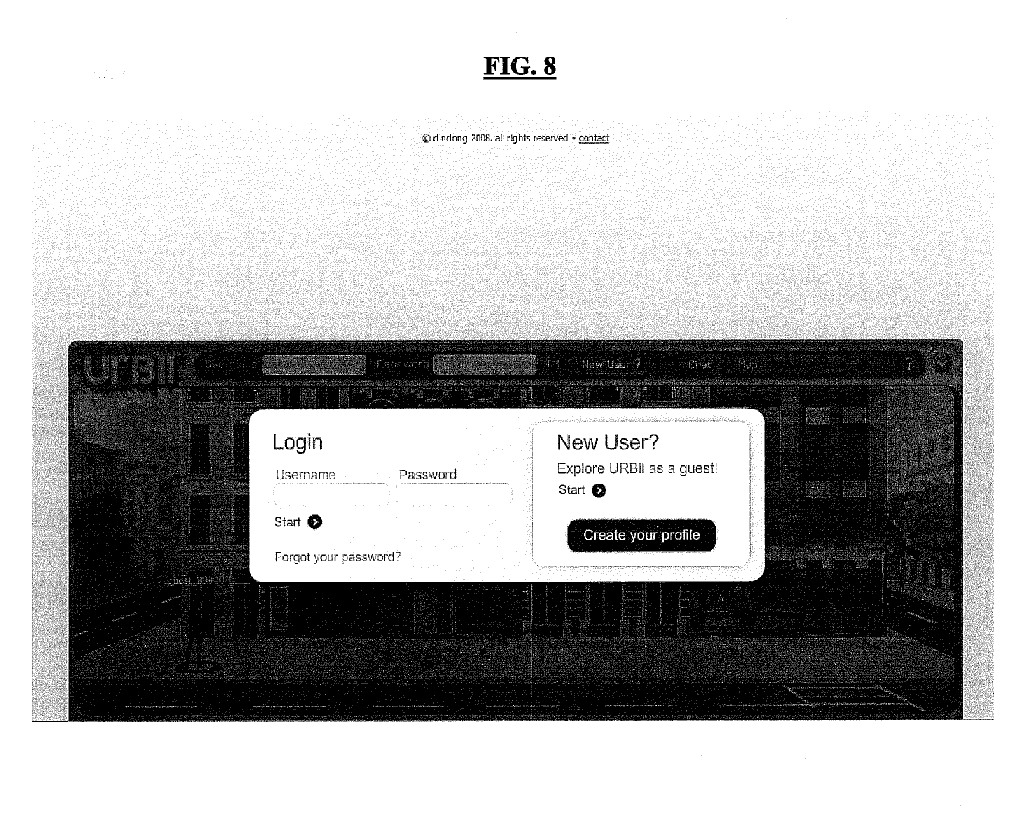

First in FIG. 7A, there is shown a screen from the webpage where the metaverse selection widget is closed. FIG. 7B is a screen from the webpage where the widget has been opened and the virtual reality street is shown. FIG. 8 is a log-in screen for the system user. Returning users can simply enter their username and password. New users will be asked to register at this point.

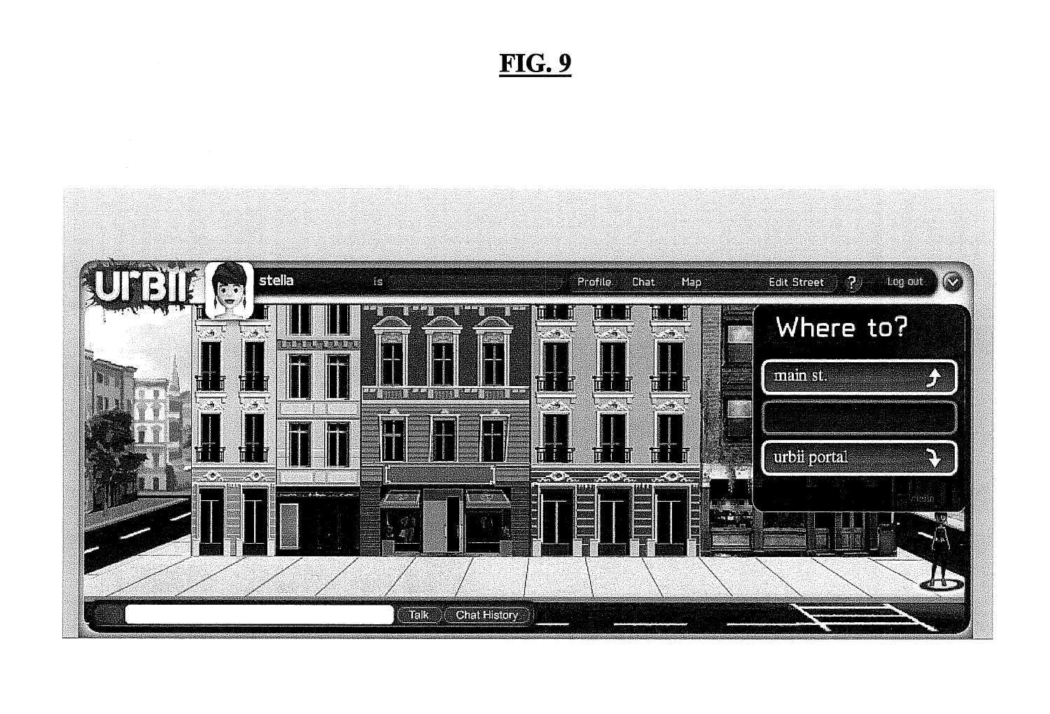

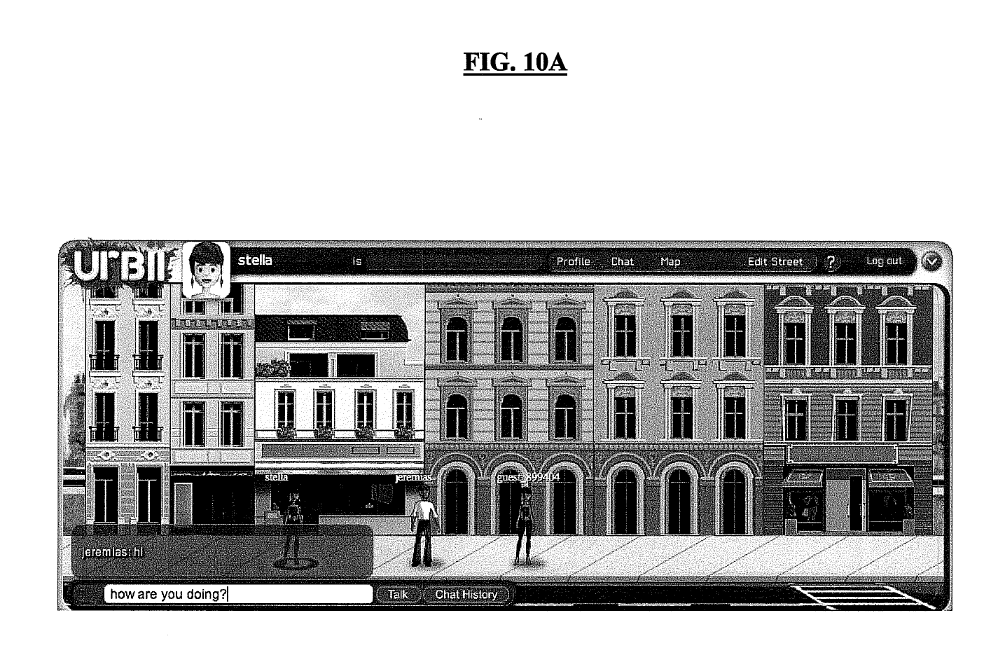

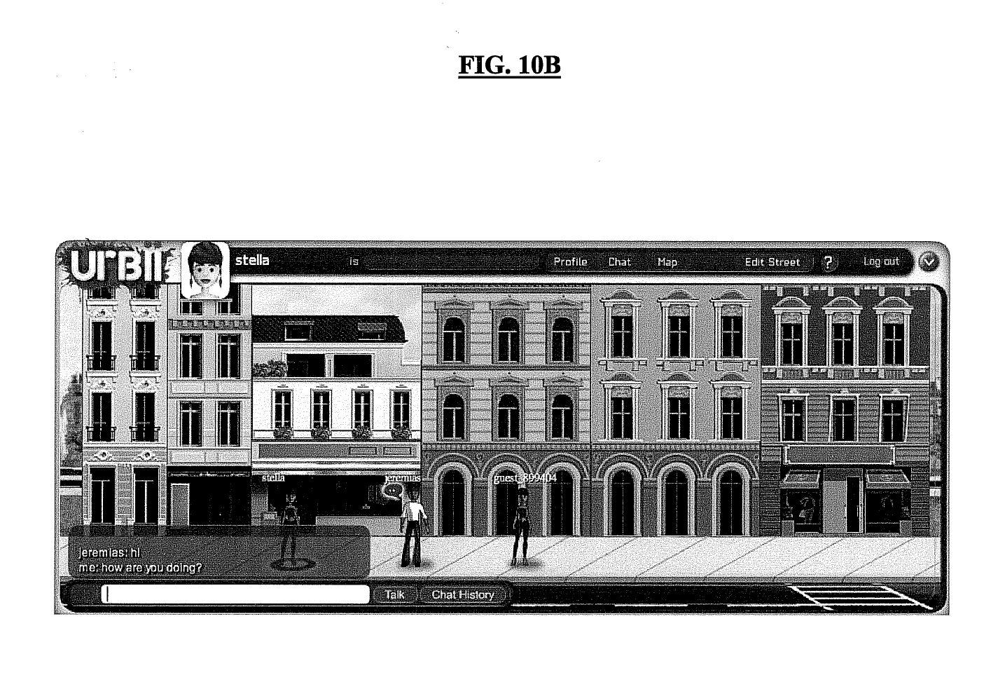

FIG. 9 is a screen from the webpage where the widget has been opened and the options for strolling by the avatar are available. FIG. 10A is a screen from the webpage where the widget has been opened and a chat sequence has been selected. FIG. 10B is a screen flowing from FIG. 10A that continues the chat sequence.

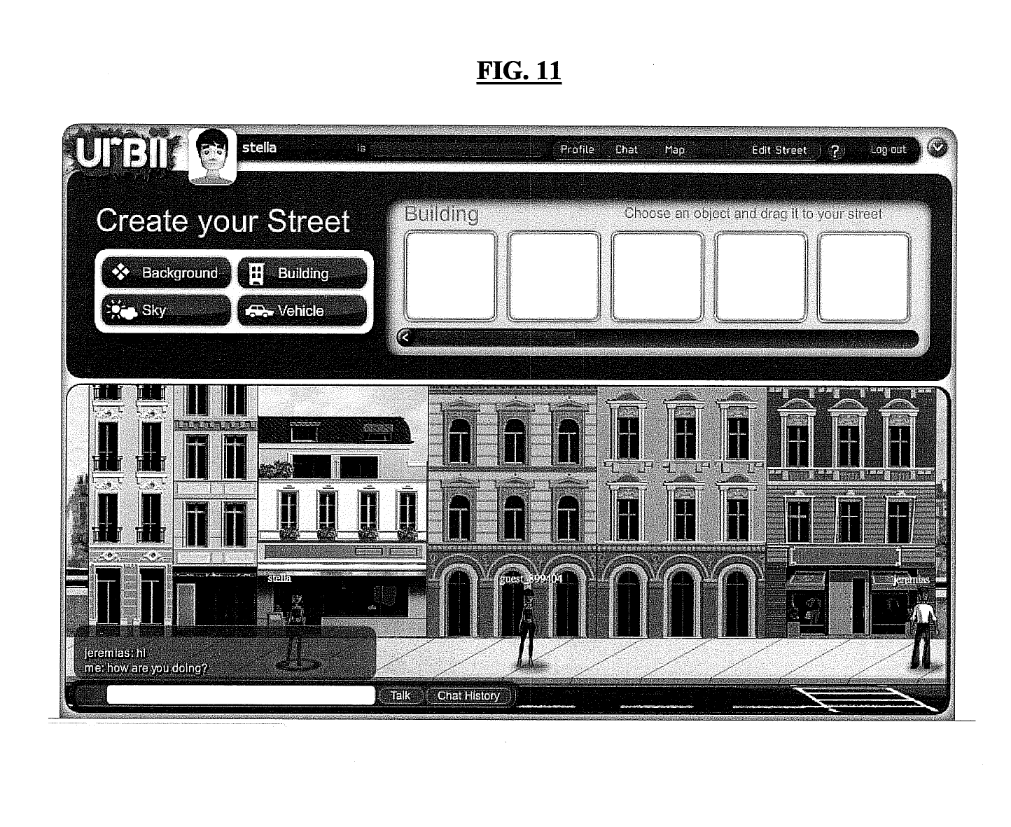

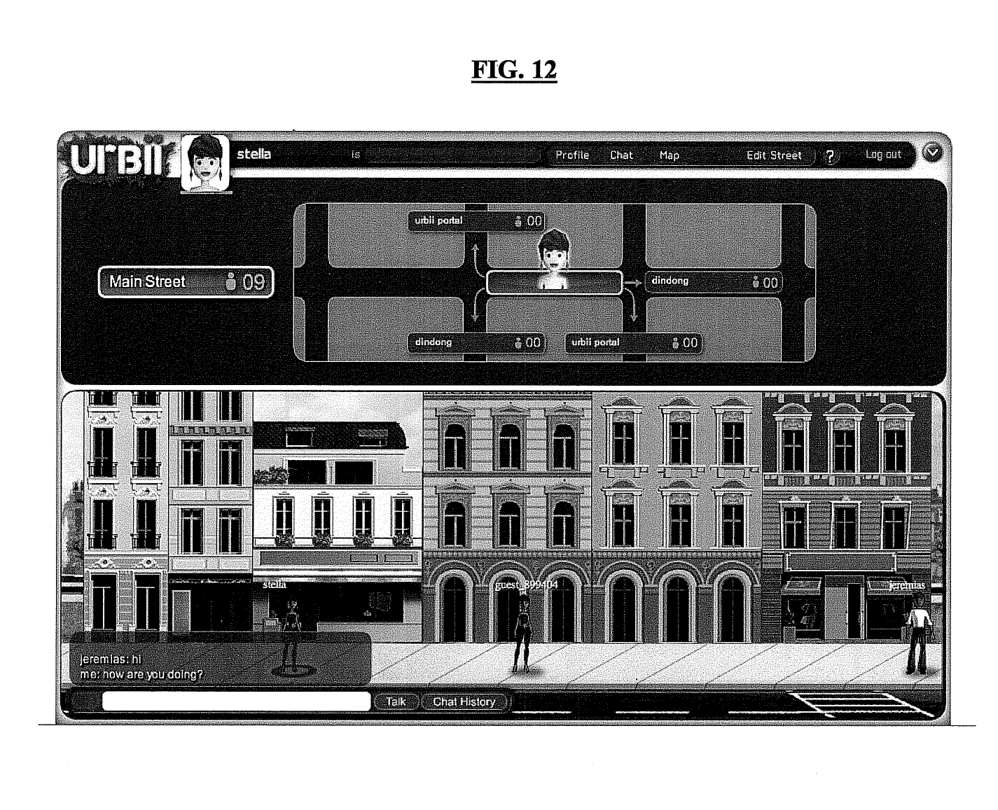

FIG. 11 is a screen from the webpage where the widget has been opened and a street customization sequence has been selected. And, in FIG. 12 there is shown a screen from the webpage where the widget has been opened and the ability to view the grid for the metaverse has been selected.

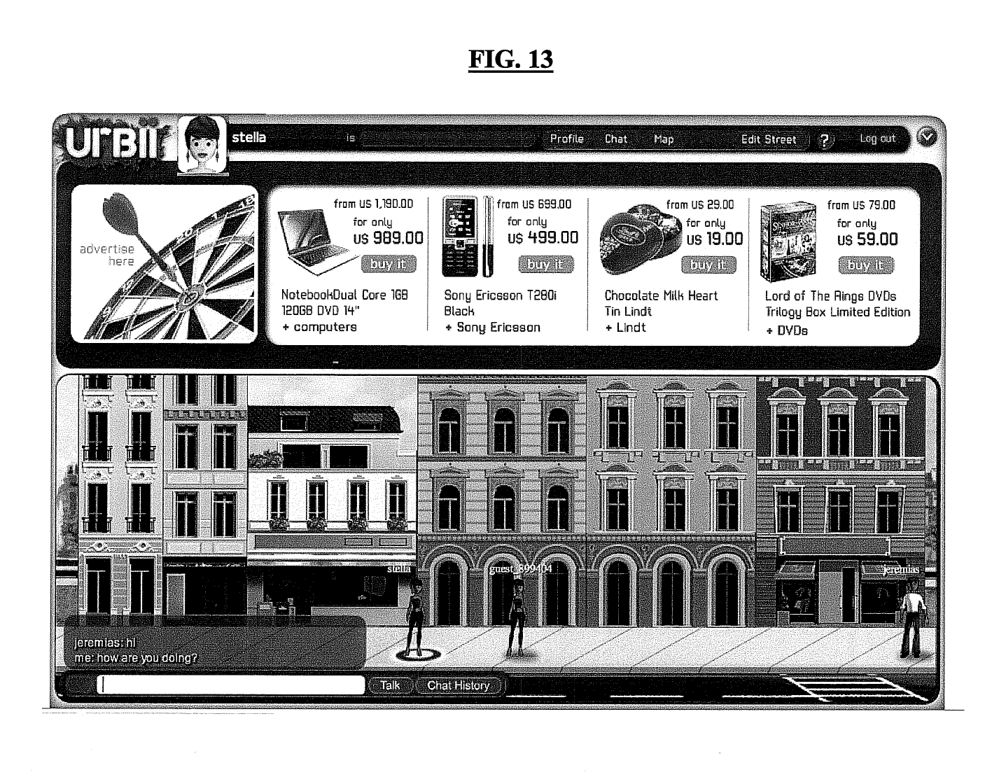

Today, advertisers, brand managers, and users alike crave more interesting advertising solutions. A simple solution is provided with the present system. In just a few clicks, a website owner creates a street, then chooses the way users will interact within their own personal environment. When this environment involves ads, it presents them in a new and interactive way to the user. And the customizability of the street gives site owners and bloggers new opportunities to foster revenue streams, since each facade can contain external links or internal applications that can be developed by anyone. System hosters can even buy ads and campaigns from the system marketplace. An example of this is shown in FIG. 13 where an advertising banner is mounted over the street.

For the system user, web navigation becomes social navigation, functioning as a social network within regular web pages. System streets can also be placed within social networking system profiles (such as FACEBOOK, then further developed into applications with extra features and games. All this makes the metaverse experience very accessible, lowering the barriers and creating a global, communal marketplace.

The present invention solves three problems at once: monetizing virtual worlds; making the metaverse experience very accessible; and, making advertising on the web more interesting and effective. All while bringing people together to add a new layer of functionality and interaction to the web.

The system is configured to generate and account for revenue in four ways. First, revenue can be derived from hosting the system grid connections and streets. Hosting websites will place bids for spots in the “most wanted” neighborhoods for every type of content. Additionally, the system can charge a small monthly fee for websites that want to host a street without any advertising on it. Second, revenue can be generated from a network of advertisers. There will be a marketplace with advertising campaigns that can be placed in the various system streets. The revenues will be shared between the system hosts and the websites that host the streets with ads. A third source of revenue can be generated from premium accounts for users and websites that host system streets, offering extra features and monthly allowances in the form of internal currency. And, revenues can be generated from the issuing of internal currency, from which the system will take a percentage in all transactions.

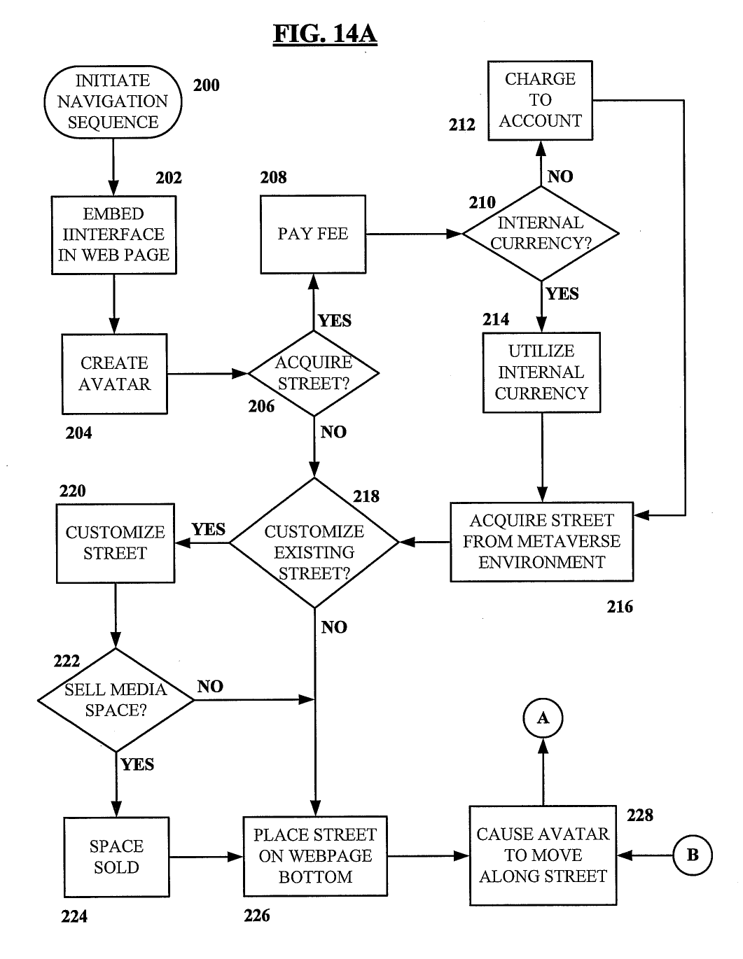

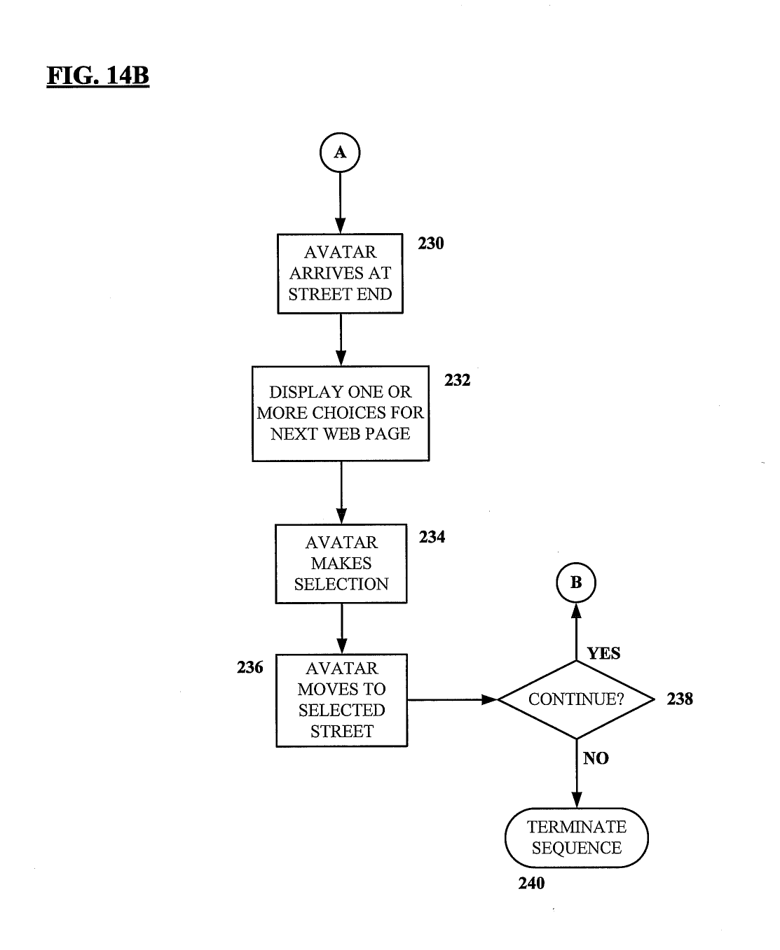

In FIG. 14A, and continued in FIG. 14B, there is shown a flowchart of the method of the present invention.

The method flow begins in FIG. 14A at step 200 where a navigation sequence is initiated. From step 200, the method flow advances to step 202 where the metaverse is established by embedding an interface in a web page, then creating an avatar, at step 204, when a mouse, under control of an environment user, moves over the interface. From step 204, the flow advances to a query at step 206.

At step 206, the method queries as to whether or not a street is to be acquired and added to the system. If the response to the query is “YES”, then a fee is initiated to the environment host at step 208 before advancing to the query at step 210. At step 210, the method flow queries as to whether or not the currency to be used is the environment's internal currency, or country currency paid by credit or debit. If the response to the query is “NO,” then the flow advances to step 212 where the fee is paid with a charge against an account. From step 212, the flow advances to step 216 where the street is acquired from the metaverse environment. If, however, the response to the query at step 210 is “YES”, then the flow advances to step 214 where the appropriate amount of internal currency is charged against the user's account before advancing to step 216.

Returning to step 206, if the response to the query is “NO,” then the flow advances to the query at step 218 which asks if the environment user wants to customize an existing street. If the response to the query is “YES,” then the flow advances to step 220 where an existing street is selected and then customized in accordance with a checklist of available features that allows a plurality of building facades to be utilized. From step 220, the method flow advances to the query at step 222 which asks if the hosting entity desires to sell media space within the confines of the selected street. The media space can be within the street itself or can be in a separate banner as depicted in FIG. 13. If the response to the query is “NO,” then the flow advances to re-enter the flow ending at step 226. If, however, the response to the query at step 222 is “YES,” then the flow advances to step 224 where the space is sold to an advertiser. The flow then advances to step 226.

Returning to step 218, if the response to the query is “NO,” then the flow advances to step 226 where the virtual reality street, serving as the central point of the environment, and associated with a particular URL, is established and placed on the bottom of a webpage. The web page itself further comprises a browser window viewable by the system user. The viewable webpage has three subsets which include: a first subset displaying a listing for a site URL; a second subset displaying site content; and, a third subset of said browser window displaying a virtual world application which is embedded in the site content.

At least one avatar is caused by the user, at step 228, to move up or down the street. From step 228, the flow advances along path A to re-enter the flow at step 230 as is shown in FIG. 14B.

The method of creating an avatar comprises the step of initiating an application which allows a user to activate a customization widget. The customization widget is activated to allow the user to select one or more visual characteristics that can be applied to the avatar. The user then makes the selection of one or more visual characteristics from a list determinative of a customized avatar.

The movement of the avatar allows it to interact with the facades or activities that are built into the street by one or more system users. Navigation of the avatar to the end of the street at step 230 causes the avatar to select from among one or more choices at step 232 for selecting a next web page. The avatar interfaces with one of the choices so as to select a next web page to navigate at step 234; then, the avatar moves from its present street to a next street at step 236.

Navigation is facilitated by the system allowing the user to host the metaverse environment within a webpage, and wherein the system further comprises a web-based server having a plurality of web pages accessible therefrom.

When the avatar has completed its journey, the flow advances to the query at step 238, which asks if the environment user wants to continue strolling the street. If the response to the query is “YES,” then the flow advances along path B to re-enter the flow at step 228 which is shown in FIG. 14A. However, if the response to the query at step 238 is “NO,” then the sequence will be terminated at step 240.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A method of navigation within a metaverse environment comprising the steps of:
(a) embedding an interface in a web page;
(b) creating an avatar when a mouse under control of an environment user moves over said interface;
(c) acquiring a street from said metaverse environment wherein said street is associated with a particular URL;
(d) placing said street on the bottom of a webpage;
(e) customizing said street with a plurality of facades; and
(f) causing said avatar to move up or down said street.

2. The method of claim 1, wherein said acquisition of said street is accomplished through a payment of a fee by a hoster to said metaverse environment.

3. The method of claim 1, further comprising the steps of:
(a) causing said avatar to arrive at an end of said street;
(b) displaying one or more choices for selecting a next web page;
(c) having said avatar interface with one of said one or more choices so as to select said one choice; and
(d) moving said avatar from said street to a second street.

4. The method of claim 3, wherein each of said one or more choices is linked to the other by a webring.

5. The method of claim 1, wherein said customizing step further comprises the step of selling media space to an advertiser.

6. The method of claim 1, wherein said metaverse environment provides an internal currency that can be converted within said environment into any currency in the real world.

7. The method of claim 1, wherein said plurality of facades comprises one or more houses.

8. The method of claim 1, wherein said plurality of facades further comprises one or more commercial buildings.

9. The method of claim 1, wherein said plurality of facades comprises one or more street lights.

10. A system for hosting a metaverse environment within a webpage and wherein said system further comprises:
(a) a web-based server having a plurality of web pages accessible therefrom;
(b) a first interface between said plurality of web pages and a user data processing system, said system further comprising a monitor and a mouse;
(c) a second interface embedded in a web page wherein said user can create an avatar when a mouse under control of said user moves over said second interface; and
(d) a virtual reality street, capable of being acquired from said metaverse environment, and wherein said virtual reality street is associated with a particular URL; and, wherein further said virtual reality street is placed on the bottom of a webpage.

11. The system of claim 10, further comprising customization means for customizing said virtual reality street.

12. The system of claim 10, wherein said virtual reality street is capable of being customized with a plurality of facades.

13. The system of claim 10, wherein said customization means further comprises means for utilizing an internal currency that can be converted within said environment into any currency in the real world.

14. The system of claim 12, wherein said plurality of facades comprises one or more houses.

15. The system of claim 12, wherein said plurality of facades further comprises one or more commercial buildings.

16. The system of claim 12, wherein said plurality of facades comprises one or more street lights.

17. The system of claim 10, wherein said web page further comprises:
(a) a browser window viewable by said user;
(b) a first subset of said browser window displaying a listing for a site URL;
(c) a second subset of said browser window displaying site content; and
(d) a third subset of said browser window displaying a virtual world application wherein said virtual world application is embedded in site content.

18. The system of claim 10, wherein each web page of said plurality of web pages is linked via webring.

19. A method of introducing an avatar to a metaverse environment, said method comprising the steps of:
(a) embedding an interface in a web page;
(b) creating an avatar under control of said metaverse environment wherein said metaverse allows a user to activate a customization widget;
(c) activating said customization widget to allow said user to select one or more visual characteristics;
(d) selecting from a list said one or more visual characteristics determinative of a customized avatar;
(e) acquiring a street from said metaverse environment wherein said street is associated with a particular URL;
(f) placing said street on the bottom of a webpage;
(g) customizing said street with a plurality of facades; and
(h) causing said avatar to move up or down said street.

20. A method of loading a metaverse environment within a networked data processing system, said method comprising the steps of:
(a) utilizing HTTP GET protocol to select a site from a browser;
(b) returning from said site to said browser a set of selected content;
(c) utilizing HTTP Get protocol to refer to a site URL so as to access an application server;
(d) transmitting a VWID URL from said application server to a database; and
(e) transmitting from said database the selected VWAPP Content to said browser.
